(19) United States
(12) Patent Application Publication
(10) Pub. No.: US 2015/0227411 A1
(43) Pub. Date: Aug. 13, 2015

(54) VERIFICATION SUPPORT APPARATUS AND METHOD FOR FORMAL VERIFICATION OF NETWORK SERVICE CHAIN IN SOFTWARE-DEFINED NETWORKING ENVIRONMENT, AND FORMAL VERIFICATION APPARATUS HAVING VERIFICATION SUPPORT APPARATUS

(71) Applicant: ELECTRONICS AND TELECOMMUNICATIONS RESEARCH INSTITUTE, Daejeon (KR)

(72) Inventors: Jong-Hwa YI, Daejeon (KR); Yun-Chul CHOI, Daejeon (KR); Seung-Ik LEE, Daejeon (KR); Myung-Ki SHIN, Seoul (KR); Hyoung-Jun KIM, Daejeon (KR)

(21) Appl. No.: 14/618,060

(22) Filed: Feb. 10, 2015

(30) Foreign Application Priority Data
Feb. 11, 2014 (KR) 10-2014-0015324

(51) Int. Cl. G06F 11/07; H04L 29/08; G06F 9/54

(52) U.S. Cl. CPC G06F 11/0784; G06F 9/542; H04L 67/10

(57) ABSTRACT

Disclosed herein is technology for formal verification of a network service chain in a software-defined networking environment. In an embodiment, a verification support apparatus for formal verification of a network service chain includes a Network Service Chain (NSC) descriptor information reception unit for receiving NSC descriptor information from an application program. An NSC configuration unit configures an NSC of multiple network services using the received NSC descriptor information. A verification request unit requests formal verification of each network service in the configured NSC from a formal verification unit.

### CROSS REFERENCE TO RELATED APPLICATION

This application claims the benefit of Korean Patent Application No. 10-2014-0015324 filed Feb. 11, 2014, which is hereby incorporated by reference in its entirety into this application.

### BACKGROUND OF THE INVENTION

1. Technical Field

The present invention generally relates to a verification support apparatus and method for the formal verification of a network service chain in a Software-Defined Networking (SDN) environment and a formal verification apparatus having the verification support apparatus and, more particularly, to technology that configures a network service chain for an application developed using multiple network services in an SDN environment, and formally verifies the network service chain.

2. Description of the Related Art

Generally, in a Software-Defined Networking (SDN) environment, a network structure is divided into an infrastructure layer, a control layer, and an application layer, and is capable of controlling the operations of switches corresponding to the infrastructure layer using software. This means that external applications can control SND network functions in a software manner. However, such external applications may cause damage in such a way as to cause errors in SDN network functions either intentionally or by the mistake of developers, and thus the preliminary verification of whether errors have occurred is required.

In this way, to verify the external applications, formal verification is generally used. That is, to verify a new external application, an SDN controller invokes a formal verification module, requests the module to verify the new external application, and receives the results of verification. When the results of verification are successful, the new external application is installed to be capable of controlling the operations of SDN switches; otherwise, the results of verification indicating that an error is present in the new external application are reported.

Meanwhile, a new application may be developed so that multiple network services that have been previously developed and used may be utilized. Korean Patent Application Publication No. 10-2011-0109146 discloses technology entitled “Behavior Fallacy Analysis Apparatus and Method”. However, typical formal verification techniques are so restrictive that it is difficult to select and combine network services and configure a network service chain depending on the operation of an SDN network required by a new application, and to verify all of multiple network services in the configured network service chain in the SDN environment.

### SUMMARY OF THE INVENTION

Accordingly, the present invention has been made keeping in mind the above problems occurring in the prior art, and an object of the present invention is to provide a formal verification support apparatus and method and a formal verification apparatus, in which a control layer configures a chain of multiple network services to verify an application program based on a network service chain in which multiple network services are configured in a software-defined networking environment, and sets verification points, thus supporting formal verification so that effective formal verification is performed.

Another object of the present invention is to provide a formal verification apparatus that has the formal verification support apparatus, thus effectively performing network service chain-based formal verification.

In accordance with an aspect of the present invention, there is provided a verification support apparatus for formal verification of Software-Defined Networking (SDN), including a Network Service Chain (NSC) descriptor information reception unit for receiving NSC descriptor information from an application program, an NSC configuration unit for configuring an NSC of multiple network services using the received NSC descriptor information, and a verification request unit for requesting formal verification of each network service in the configured NSC from a formal verification unit.

The verification support apparatus may further include a verification result determination unit for notifying the application program of error information when an error is present in results of verification of each network service received from the formal verification unit.

The NSC descriptor information may include one or more of basic information of the application program, information of network resource requirements, a number of network services used, descriptor information of each network service, and execution operation sequence information of network services.

The NSC configuration unit may configure the NSC of the network services using the execution operation sequence information of the network services included in the NSC descriptor information.

The verification support apparatus may further include a verification point setting unit for setting verification points for respective network services in the NSC when the NSC is configured by the NSC configuration unit.

The verification request unit may be configured to, when the verification points are set for the respective network services, request verification by sequentially transmitting pieces of descriptor information of the network services connected to the verification points to the formal verification unit.

The verification support apparatus may further include an NSC reconfiguration unit for, when an event related to the configured NSC is received, updating or reconfiguring the NSC based on the received event.

The event related to the NSC may include one or more of an event for replacement of a network service in the NSC, a network service error event, and a load balancing event.

In accordance with another aspect of the present invention, there is provided a verification support method for formal verification of Software-Defined Networking (SDN), including receiving a Network Service Chain (NSC) descriptor information from an application program, configuring an NSC of multiple network services using the received NSC descriptor information, and requesting formal verification of each network service in the configured NSC from a formal verification unit.

The verification support method may further include checking results of verification of each network service received from the formal verification unit, and notifying the application program of error information when an error is present in the results of verification.

Configuring the NSC may include configuring the NSC of the network services using execution operation sequence information of network services included in the received NSC descriptor information.

Configuring the NSC may include setting verification points for respective network services in the NSC when the NSC is configured.

Requesting the formal verification may include, when the verification points are set for the respective network services, sequentially transmitting pieces of descriptor information of the network services connected to the verification points to the formal verification unit.

The verification support method may further include receiving an event related to the configured NSC, and updating or reconfiguring the NSC based on the received event.

In accordance with a further aspect of the present invention, there is provided a formal verification apparatus for Software-Defined Networking (SDN), including a verification support unit for, when Network Service Chain (NSC) descriptor information is received from an application program, configuring a chain of network services based on the received NSC descriptor information, and requesting verification of each network service in the configured chain, and a formal verification unit for verifying each network service requested by the verification support unit, and transmitting results of verification to the verification support unit.

The formal verification unit may include a flow information acquisition unit for adding flow information of each network service received from the verification support unit to overall SDN network flow information, based on descriptor information of the network service, a formal language conversion unit for converting the overall SDN network flow information to which the flow information is added into a predefined formal language, and a verification execution unit for verifying the network service based on the formal language.

The verification execution unit may generate a predefined graph using information of the formal language, and check an error by tracking a link on the predefined graph for a flow corresponding to the network service.

The formal verification unit may further include an interface unit for receiving descriptor information of the network service from a verification support unit and transmitting results of verification of the network service to the verification support unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a software-defined networking environment to which a formal verification apparatus according to an embodiment is applied;

FIG. 2 is a detailed block diagram showing the verification support unit of the formal verification apparatus according to an embodiment;

FIG. 3 is a diagram showing an example of network service chain descriptor information;

FIG. 4 is a diagram illustrating the configuration of a network service chain and the setting of verification points using the verification support unit of FIG. 2;

FIG. 5 is a diagram illustrating the reconfiguration of a network service chain and the resetting of verification points using the verification support unit of FIG. 2;

FIG. 6 is a detailed block diagram showing the formal verification unit of the formal verification apparatus according to an embodiment;

FIG. 7 is a flowchart showing a formal verification support method performed by the verification support unit according to an embodiment; and

FIG. 8 is a flowchart showing a formal verification method performed by the formal verification unit according to an embodiment.

### DESCRIPTION OF THE PREFERRED EMBODIMENTS

Details of embodiments are included in detailed description and attached drawings. The features and advantages of technology disclosed in the present invention and methods for achieving them will be more clearly understood from detailed description of the following embodiments taken in conjunction with the accompanying drawings. Reference now should be made to the drawings, in which the same reference numerals are used throughout the different drawings to designate the same or similar components.

Hereinafter, embodiments of a verification support apparatus and method for the formal verification of a network service chain (hereinafter referred to as an ‘NSC’) in a software-defined networking (hereinafter referred to as ‘SDN’) environment and a formal verification apparatus having the verification support apparatus will be described in detail with reference to the attached drawings.

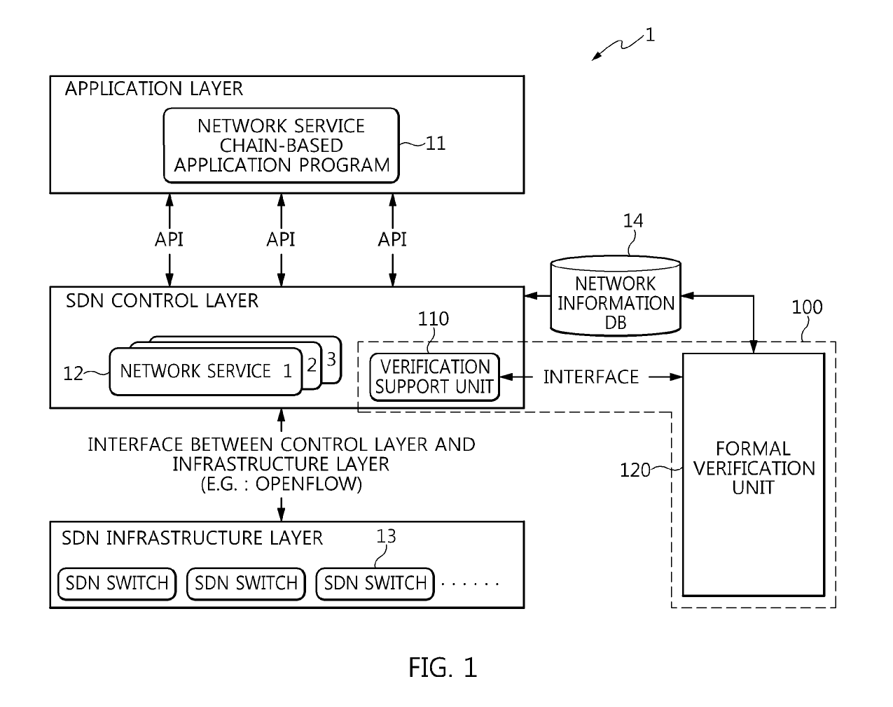

FIG. 1 is a configuration diagram showing an SDN environment-based system to which a formal verification apparatus according to an embodiment is applied.

Referring to FIG. 1, a formal verification apparatus 100 according to an embodiment of the present invention includes a verification support unit 110 for supporting NSC-based formal verification, and a formal verification unit 120. In this case, as shown in the drawing, the verification support unit 110 and the formal verification unit 120 may be implemented or mounted in separate hardware devices to be physically distinguished from each other, but the configuration thereof is not necessarily limited thereto.

Generally, an SDN environment-based system 1 is composed of an application layer, a control layer, and an infrastructure layer, as shown in the drawing, and may control the operations of SDN switches 13 corresponding to the infrastructure layer using software. That is, external applications 11 present in the application layer may control SDN network functions using software.

The verification support unit 110, which is located in the control layer of the SDN environment, configures an NSC of multiple network services 12 and requests the formal verification unit 120 to verify each network service 12 using the configured NSC.

Further, when there is a need to replace any network service belonging to the configured NSC or when load balancing on the network is required, the verification support unit 110 may reconfigure or update the previously configured NSC.

In addition, when the results of formal verification of each network service are received from the formal verification unit 120, the verification support unit 110 collects the results of verification. If an error is present in the results of verification, the verification support unit 110 transmits information of the error to the corresponding application program 11 of the application layer. If there is no error in the results of verification, the network services are downloaded to the SDN switches 13 of the infrastructure layer and are then reflected in the operation of the network.

When a request for verification of each network service is received from the verification support unit 110, the formal verification unit 120 verifies each requested network service and transfers the results of verification to the verification support unit 110.

Here, the formal verification unit 120 may acquire the flow information of the overall network topology from a network information database (DB) 14, add flow information corresponding to a verification target network service to the acquired flow information of the overall network topology, and verify the verification target network service using the overall flow information.

In this case, the formal verification unit 120 may convert overall flow information to which the flow information corresponding to the verification target network service is added into a predefined formal language (e.g., packet-based Algebra of Communicating Shared Resources: pACSR), and may perform formal verification using the formal language.

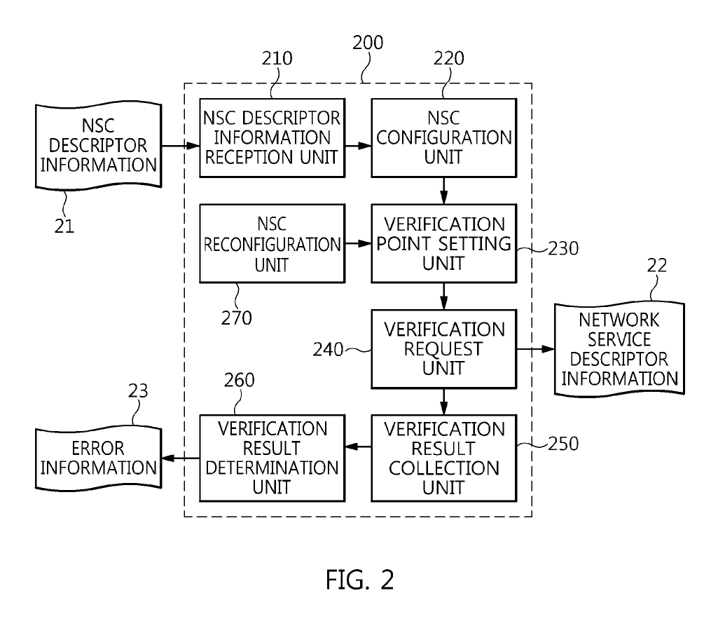

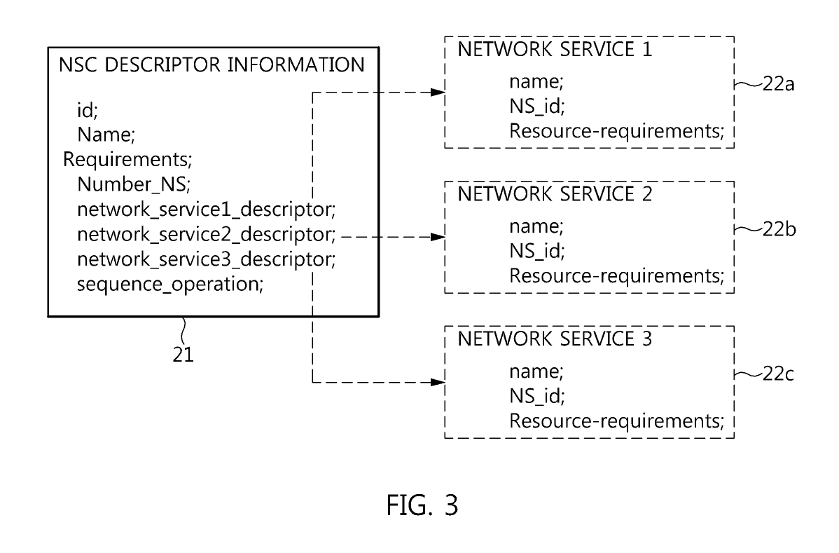

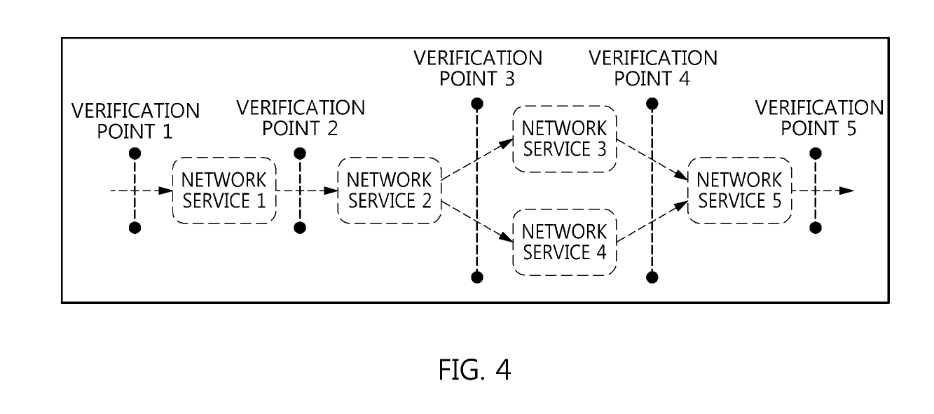

FIG. 2 is a detailed block diagram showing the verification support unit of the formal verification apparatus according to an embodiment. FIG. 3 is a diagram showing an example of Network Service Chain (NSC) descriptor information. FIG. 4 is a diagram illustrating the configuration of an NSC and the setting of verification points using the verification support unit of FIG. 2.

Referring to FIG. 2, a verification support unit 200 according to an embodiment includes an NSC descriptor information reception unit 210, an NSC configuration unit 220, a verification point setting unit 230, a verification request unit 240, a verification result collection unit 250, a verification result determination unit 260, and an NSC reconfiguration unit 270.

The NSC descriptor information reception unit 210 receives NSC descriptor information 21 about multiple network services from an application program.

Below, referring additionally to FIG. 3, the NSC descriptor information 21 may include, in detail, the basic information (id, Name) of the application program, the information of network resource requirements (Requirements), the number of network services used (Number NS), descriptor information of each network service (network_service1 descriptor, network_service2 descriptor, and network_service3 descriptor), execution operation sequence information of the network services (sequence_operation), etc. Further, the descriptor information 22a, 22b, or 22c of each network service may include the name, ID (NS_id), and the resource requirements of the corresponding network service.

When the NSC descriptor information 21 is received from an application program, the NSC configuration unit 220 configures an NSC of network services using the execution operation sequence information (sequence_operation) of the network services included in the NSC descriptor information 21.

FIG. 4 illustrates an example in which the NSC configuration unit 220 configures an NSC using the execution operation sequence information of individual network services when pieces of NSC descriptor information of five network services 1 to 5 are received. Referring to FIG. 4, it can be seen that, after network service 1 is executed, network service 2 is executed, and then network services 3 and 4 are simultaneously executed, prior to the execution of network service 5.

When the NSC is configured by the NSC configuration unit 220, the verification point setting unit 230 sets verification points in the NSC. Referring to FIG. 4, five verification points are set in the configured NSC. That is, the verification point setting unit 230 may set verification points at the starting point and the end point of each network service in the NSC depending on the execution sequence when the NSC is configured.

For example, for network service 1, verification point 1 is set at the starting point thereof, and verification point 2 is set at the end point thereof. Thereafter, for network service 2, since verification point 2 has already been set at the starting point thereof, verification point 3 is set at the end point thereof. Then, for both network services 3 and 4 that are simultaneously executed according to the configuration of the NSC, since verification point 3 has already been set at the starting point thereof, verification point 4 is set at the end point thereof. Similarly, for network service 5, verification point 5 is set at the end point thereof.

The verification request unit 240 requests the formal verification unit to verify each network service in the NSC. In this case, when the verification points are set by the verification point setting unit 230, the verification request unit 240 may request the formal verification unit to verify the network services in the sequence of network services connected to the verification points from the first verification point. Further, the verification request unit 240 may request verification by transmitting pieces of descriptor information 22 of the network services connected to the verification points, among pieces of descriptor information of network services included in the NSC descriptor information 21, to the formal verification unit.

For example, referring to FIG. 4, when five verification points 1, 2, 3, 4, and 5 are set in the NSC, as shown in the drawing, the verification request unit 240 requests the formal verification unit to verify network service 1 connected to the first verification point 1 by transmitting the descriptor information of the network service 1 (network_service1_descriptor), included in the NSC descriptor information 21 received from the application program, to the formal verification unit.

Thereafter, when the results of verification of the network service 1 are received from the formal verification unit, the verification request unit 240 transmits the descriptor information of network service 2 (network_service2_descriptor) connected to subsequent verification point 2 to the formal verification unit.

In this way, when the sequence reaches verification point 5, a network service connected to the verification point 5, that is, a network service requiring verification, is not present any more, and thus a verification request is terminated.

The verification result collection unit 250 collects the verification results of respective network services received from the formal verification unit at the request of the verification request unit 240. In this case, the verification result collection unit 250 may store the results of verification in a verification result DB (not shown) whenever the results of verification of each network service are received, and may collect the results of verification of all network services.

When the results of verification of all network services in the NSC are collected, the verification result determination unit 260 determines whether an error is present in the verification results. If it is determined that an error is present in the verification results, the verification result determination unit 260 transmits error information 23 to the application program. If it is determined that an error is not present in the verification results, the verification result determination unit 260 allows the pieces of network service descriptor information to be downloaded to the SDN switches.

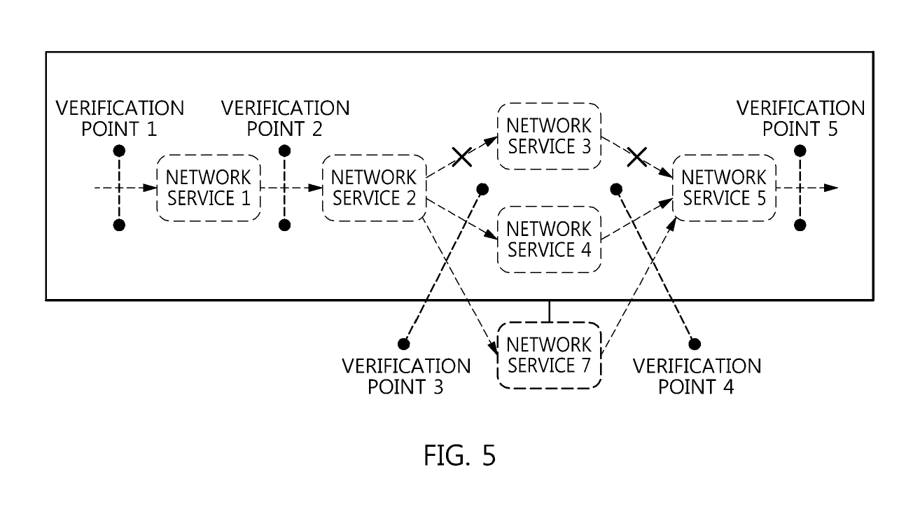

FIG. 5 is a diagram illustrating the reconfiguration of a network service chain and resetting of verification points using the verification support unit of FIG. 2.

Referring back to FIG. 2, it can be seen that when an event related to a previously configured NSC is received, the NSC reconfiguration unit 270 of the verification support unit 200 may update or reconfigure the previously configured NSC depending on the received event. In this case, the event may include an event for the replacement of a network service in the previously configured NSC, a network service error event, a network load balancing requirement event, etc.

FIG. 5 illustrates an example in which the NSC reconfiguration unit 270 receives an event for replacing network service 3 with network service 7 and reconfigures the previously configured NSC. As shown in the drawing, the NSC reconfiguration unit 270 removes a link ranging from the network service 2 to network service 5 via the network service 3 and deletes the network service 3 in response to the received replacement event. Further, a link ranging from the network service 2 to the network service 5 via the network service 7 is added to the NSC, and thus the NSC is reconfigured.

Once the NSC is reconfigured, the verification point setting unit 230 sets verification points in the reconfigured NSC, and then repeats a procedure for verifying the network services in the reconfigured NSC, as described above.

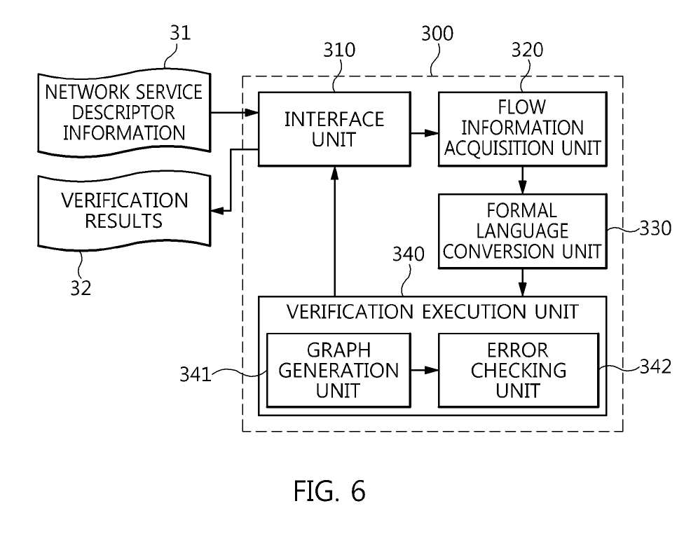

FIG. 6 is a detailed block diagram showing the formal verification unit of the formal verification apparatus according to an embodiment.

Referring to FIG. 6, the formal verification unit 300 according to the embodiment may include an interface unit 310, a flow information acquisition unit 320, a formal language conversion unit 330, and a verification execution unit 340.

The interface unit 310 receives a verification request together with network service descriptor information 31 from the verification support unit 200. Further, when the verification of network services requested to be verified has been completed by the verification execution unit 340, the interface unit 310 transmits the results of verification to the verification support unit 200.

When a verification request for network services is received, the flow information acquisition unit 320 acquires flow information of overall SDN network topology information from a network information DB using the network service descriptor information. Further, the flow information acquisition unit 320 adds flow information corresponding to each network service that is a verification target to the flow information of the overall SDN network topology information.

The formal language conversion unit 330 converts the overall flow information to which the flow information corresponding to the verification target network service is added into a formal language that is a predefined specification language for formal verification. In this case, the formal language may be, for example, packet based Algebra of Communicating Shared Resources (pACSR).

The verification execution unit 340 verifies the verification target network service using the formal language.

As shown in FIG. 6, the verification execution unit 340 may include a graph generation unit 341 and an error check unit 342.

The graph generation unit 341 generates a predefined transition graph, for example, a Symbolic Transition Graph (STG), for the verification target network service using the formal language.

The error check unit 342 checks whether an error is present along the links of the graph generated by the graph generation unit 341. In this case, the error check unit 342 checks the presence of an error along the graph links from the starting point to the end point of the flow corresponding to the verification target network service on the graph, and transmits the results of verification to the verification support unit through the interface unit 310.

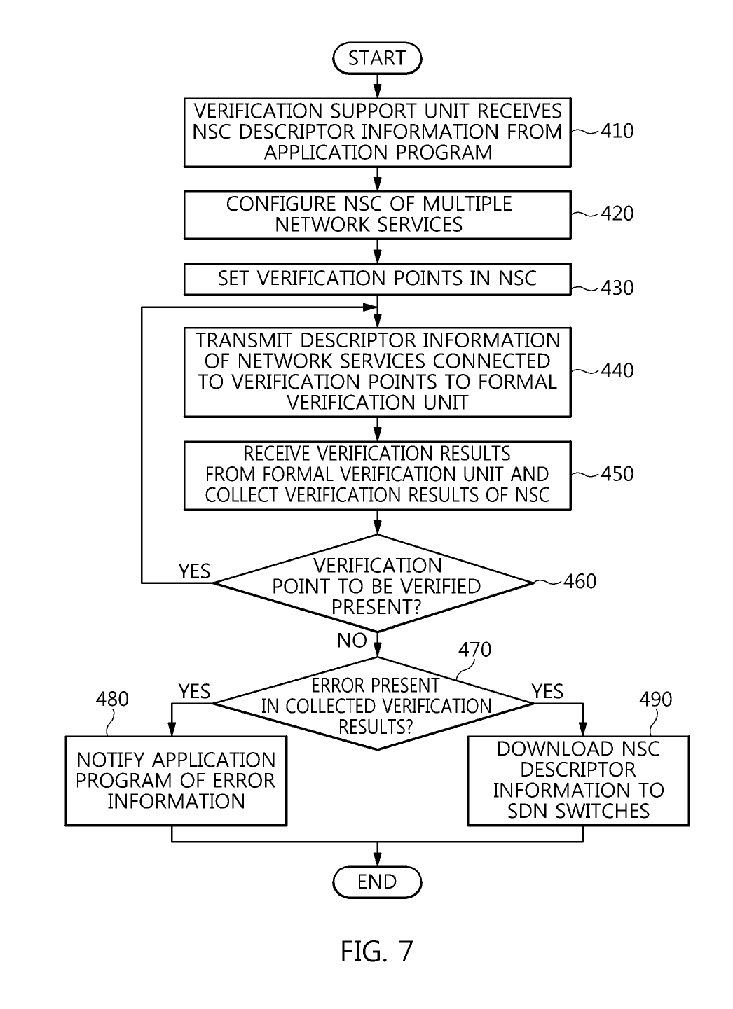

FIG. 7 is a flowchart showing a formal verification support method performed by the verification support unit according to an embodiment.

The verification support method for the formal verification of NSC-based network services will be described below with reference to FIG. 7. First, the verification support unit receives NSC descriptor information about multiple network services from an application program at step 410. Here, as illustrated in FIG. 3, the NSC descriptor information may include the basic information of the application program, the information of network resource requirements, the number of network services used, the descriptor information of each network service, the execution operation sequence information of network services, etc.

Next, by using the received NSC descriptor information, an NSC of multiple network services is configured at step 420, and verification points for respective network services in the configured NSC are set at step 430. As described above in detail with reference to FIG. 4, the verification points may be set at the starting point and the end point of each network service.

Thereafter, when the verification points are set, pieces of descriptor information of network services, sequentially connected to the verification points from a first verification point, are transmitted to the formal verification unit, and thus the verification of the network services is requested from the formal verification unit at step 440.

Then, the results of verification are received from the formal verification unit, and the results of the verification of the overall NSC are collected at step 450.

Then, when there is a subsequent verification point to be verified at step 460, a procedure starting from the step 440 of transmitting the descriptor information of a network service connected to the subsequent verification point to the formal verification unit is repeated. If there is no subsequent verification point to be verified at step 460, a procedure of checking the collected verification results is performed at step 470.

If the collected verification results are checked, and an error is present in the collected verification results at step 470, notification of error information is provided to the application program at step 480. If an error is not present in the collected verification results, the NSC descriptor information is downloaded to SDN switches at step 490.

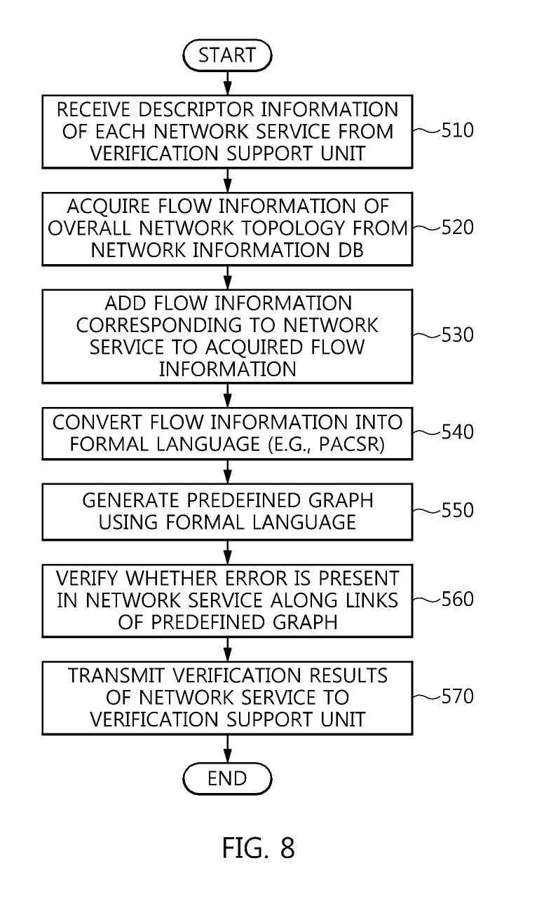

FIG. 8 is a flowchart showing a formal verification method performed by the formal verification unit according to an embodiment. A procedure in which the formal verification unit formally verifies each verification target network service received from the verification support unit will be described below with reference to FIG. 8.

First, the formal verification unit receives the descriptor information of each verification target network service from the verification support unit at step 510.

Thereafter, the flow information of overall SDN network topology is acquired from the network information DB at step 520, and flow information corresponding to the received verification target network service is added to the acquired flow information at step 530.

Then, the overall flow information to which flow information corresponding to the verification target network service is added is converted into a predefined formal language (e.g., pACSR) at step 540.

Thereafter, a predefined graph, for example, a STG, is generated using the formal language at step 550.

Further, whether an error is present in the verification target network service may be verified along the links of the generated predefined graph at step 560. In this case, whether an error is present may be checked along the links from the starting point to the end point of the flow corresponding to the verification target network service on the generated graph.

When the verification of the verification target network service is completed at step 560, the results of verification are transmitted to the verification support unit at step 570.

In accordance with the disclosed embodiments, when a new application service is developed using multiple network services, a malfunction that may occur when each network service is executed on the SDN network may be effectively verified either previously or during run time (execution time).

As described above, when a new application service, that is, an NSC-based application service, is developed using multiple network services, an operation that may occur when each network service is executed on an SDN network may be discovered either previously or during run time, thus preventing a possible error that may occur in SDN network functions.

Further, the verification of an NSC-based application service implemented by external developers is performed, and the results of verification are reported, thus activating the development of applications in an SDN environment.

Those skilled in the art to which the present embodiments pertain will appreciate that the present invention may be implemented in other detailed forms without changing the technical spirit or essential features of the present invention. Therefore, the above-described embodiments should be understood to be exemplary rather than restrictive in all aspects.

What is claimed is:

1. A verification support apparatus for formal verification of Software-Defined Networking (SDN), comprising:
a Network Service Chain (NSC) descriptor information reception unit for receiving NSC descriptor information from an application program;
an NSC configuration unit for configuring an NSC of multiple network services using the received NSC descriptor information; and
a verification request unit for requesting formal verification of each network service in the configured NSC from a formal verification unit.

2. The verification support apparatus of claim 1, further comprising a verification result determination unit for notifying the application program of error information when an error is present in results of verification of each network service received from the formal verification unit.

3. The verification support apparatus of claim 1, wherein the NSC descriptor information includes one or more of basic information of the application program, information of network resource requirements, a number of network services used, descriptor information of each network service, and execution operation sequence information of network services.

4. The verification support apparatus of claim 3, wherein the NSC configuration unit configures the NSC of the network services using the execution operation sequence information of the network services included in the NSC descriptor information.

5. The verification support apparatus of claim 1, further comprising a verification point setting unit for setting verification points for respective network services in the NSC when the NSC is configured by the NSC configuration unit.

6. The verification support apparatus of claim 5, wherein the verification request unit is configured to, when the verification points are set for the respective network services, request verification by sequentially transmitting pieces of descriptor information of the network services connected to the verification points to the formal verification unit.

7. The verification support apparatus of claim 1, further comprising an NSC reconfiguration unit for, when an event related to the configured NSC is received, updating or reconfiguring the NSC based on the received event.

8. The verification support apparatus of claim 7, wherein the event related to the NSC includes one or more of an event for replacement of a network service in the NSC, a network service error event, and a load balancing event.

9. A verification support method for formal verification of Software-Defined Networking (SDN), comprising:
receiving a Network Service Chain (NSC) descriptor information from an application program;
configuring an NSC of multiple network services using the received NSC descriptor information; and
requesting formal verification of each network service in the configured NSC from a formal verification unit.

10. The verification support method of claim 9, further comprising:
checking results of verification of each network service received from the formal verification unit; and
notifying the application program of error information when an error is present in the results of verification.

11. The verification support method of claim 9, wherein configuring the NSC comprises configuring the NSC of the network services using execution operation sequence information of network services included in the received NSC descriptor information.

12. The verification support method of claim 9, wherein configuring the NSC comprises setting verification points for respective network services in the NSC when the NSC is configured.

13. The verification support method of claim 12, wherein requesting the formal verification comprises, when the verification points are set for the respective network services, sequentially transmitting pieces of descriptor information of the network services connected to the verification points to the formal verification unit.

14. The verification support method of claim 9, further comprising:
receiving an event related to the configured NSC; and
updating or reconfiguring the NSC based on the received event.

15. A formal verification apparatus for Software-Defined Networking (SDN), comprising:
a verification support unit for, when Network Service Chain (NSC) descriptor information is received from an application program, configuring a chain of network services based on the received NSC descriptor information, and requesting verification of each network service in the configured chain; and
a formal verification unit for verifying each network service requested by the verification support unit, and transmitting results of verification to the verification support unit.

16. The formal verification apparatus of claim 15, wherein the formal verification unit comprises:
a flow information acquisition unit for adding flow information of each network service received from the verification support unit to overall SDN network flow information, based on descriptor information of the network service;
a formal language conversion unit for converting the overall SDN network flow information to which the flow information is added into a predefined formal language; and
a verification execution unit for verifying the network service based on the formal language.

17. The formal verification apparatus of claim 16, wherein the verification execution unit generates a predefined graph using information of the formal language, and checks an error by tracking a link on the predefined graph for a flow corresponding to the network service.

18. The formal verification apparatus of claim 16, wherein the formal verification unit further comprises an interface unit for receiving descriptor information of the network service from a verification support unit and transmitting results of verification of the network service to the verification support unit.
